(19) United States
(12) Patent Application Publication
(10) Pub. No.: US 2012/0312174 A1
(43) Pub. Date: Dec. 13, 2012

(54) Single Cup Coffee and Tea Brewing and Ejection System

(76) Inventor: David Lambert, Memphis, TN (US)

(21) Appl. No.: 13/517,564

(22) Filed: Jun. 13, 2012

Related U.S. Application Data
(60) Provisional application No. 61/496,484, filed on Jun. 13, 2011.

(51) Int. Cl. A47J 31/00

(52) U.S. Cl. 99/295

(57) ABSTRACT

A pod encapsulated brewing machine allowing a user to brew coffee or tea within the device using premeasured sealed filter pods then eject the pod from the machine into a waste receptacle for disposal without the user having to touch the pod.

### CROSS-REFERENCE TO RELATED APPLICATIONS

This application claims the benefit of U.S. Provisional Application No. 61/496,484, filed Jun. 13, 2011.

### BACKGROUND OF THE INVENTION

The present invention relates to single serve brewing devices, particularly to single serve brewing devices for use with encapsulated brewing pods, such as used to brew coffee, tea or the like. Coffee pods simplify individual beverage brewing by pre-measuring the beverage grounds within a porous filter paper that can be easily and neatly disposed of when complete. In existing pod brewing systems without pod ejection systems, when the brew cycle is complete, the user is required to physically remove the brew pod from the brew chamber, an act often neglected or disliked by the user because of having to touch a moist beverage pod that can stain fingers or clothing. In brewing systems capable of ejecting the pod from the brewing chamber, these systems generally possess a complicated ejection system which is expensive to construct and increases the likelihood of mechanical failure. Many of these systems rely upon electromechanical synchronized automation to eject the pod. There exists a need for a simplified and reliable brewing system capable of ejecting the pod into a suitable waste receptacle capable utilizing a simple natural motion of the user's hand.

### BRIEF SUMMARY OF THE INVENTION

The present invention allows a user to brew a single serving of their choice of beverage in a mug from a beverage pod then eject the pod from the brewing machine without ever having to touch the pod. The invention is designed such that once brewing is complete, the ground coffee or tea may be ejected from the machine into a waste bin by simply releasing brew chamber parts then sliding a lever arm towards the trash bin. The bin itself may be completely disposable, such as the bin being an empty pod container, with or without a separate liner. The invention's ejection mechanism is comprised of a slider and a cam that, when the slider impinges upon the cam, the cam presses the pod from the slider, dislodging it and allowing it to fall into the trash bin.

To use the invention, the operator places a mug below the brew chamber and pivots the pivot arm upward and places a beverage pod, such as a coffee pod, inside the pod alignment hole in the slider. The user then closes and secures the pivot arm, locking the pivot arm into place and sealing the brew chamber. The brewing cycle then is initiated, forcing hot water through the beverage pod. In the last few seconds of the brew cycle, air is forced into the brew chamber, removing excess water from the brew chamber and pod. Once the brew cycle is complete, the user may remove their mug, release the tension on the brew chamber and move the slider towards the trash bin. Once the slider hits the cam, the cam ejects the pod, readying the machine for the next beverage pod.

The relative few parts of the invention make it a simple robust design that is easier to operate and manufacture for reduced cost and complexity when compared to other machines capable of ejecting the pod. The positive pressing of the cam against the pod ensures ejection of the pod and eliminates the chances of the pod sticking to the ejection slide or other parts of the machine. The activation of the cam by pressing upon the outer edge of the slider allows the user's energy to eject the pod while ensuring the pod is not pinched between the cam and the slider pod aperture.

### BRIEF DESCRIPTION OF THE DRAWINGS

The invention is illustrated by the accompanying drawings, in which:

FIG. 1A is a front perspective view of the invention showing the invention brewing a beverage pod and dispensing the beverage into a user's mug.

FIG. 1B is a side view of a typical beverage pod.

FIG. 1C is a top view of a typical beverage pod.

FIG. 2 is a front perspective view of the invention showing the pivot arm in an open position allowing a user to load the desired beverage pod, top covers removed.

FIG. 3 is a front perspective view of the invention showing the pivot arm in an open position with the slider moved to the left ready to eject the pod, top covers removed.

FIG. 4 is a front perspective view of the invention showing the pivot arm in an open position with the slider moved to the left the ejection mechanism ejecting the pod, top covers removed.

FIG. 5 is a top view of the invention showing the slider and ejection mechanism, the pivot arm and top covers removed.

FIG. 6 is a top view of the invention showing the slider, and ejection mechanism, the slider moved to the left ready to eject the pod, the pivot arm and top covers removed.

FIG. 7 is a top view of the slider.

FIG. 8 is a cross-section of the slider taken on line 8-8 in FIG. 7.

FIG. 9 is a partial side view of the ejection mechanism showing the slider approaching the ejection cam, top cover removed.

FIG. 10 is a partial side view of the ejection mechanism showing the slider impinging upon the ejection cam and the pod ejecting, top cover removed.

FIG. 11A is a top view of the invention, showing the brew base plate, slider and ejection mechanism, top covers and pivot arm removed.

FIG. 11B is a cross section of the slider arm, brew base plate and top plate of the invention taken on line 11B-11B of FIG. 11A.

FIG. 12 is a top view of the invention showing the ejection mechanism, pivot arm in an open position and slider with the top covers removed.

FIG. 13 is a cross-section the pivot arm in an open position and slider taken on line 13-13 in FIG. 12.

FIG. 14 is a top view of the invention showing the ejection mechanism, pivot arm in a closed position and slider with the top covers removed.

FIG. 15 is a cross-section the pivot arm in a closed position and slider taken on line 15-15 in FIG. 14.

FIG. 16 is a cross-section the pivot arm in an open position and slider taken on line 16-16 in FIG. 12.

FIG. 17 is a cross-section the pivot arm in a closed position and slider taken on line 17-17 in FIG. 14.

FIG. 18 is a schematic diagram of the water heating and pressurization system.

FIG. 19 is and exploded diagram of the major components of the invention.

### DETAILED DESCRIPTION OF THE INVENTION

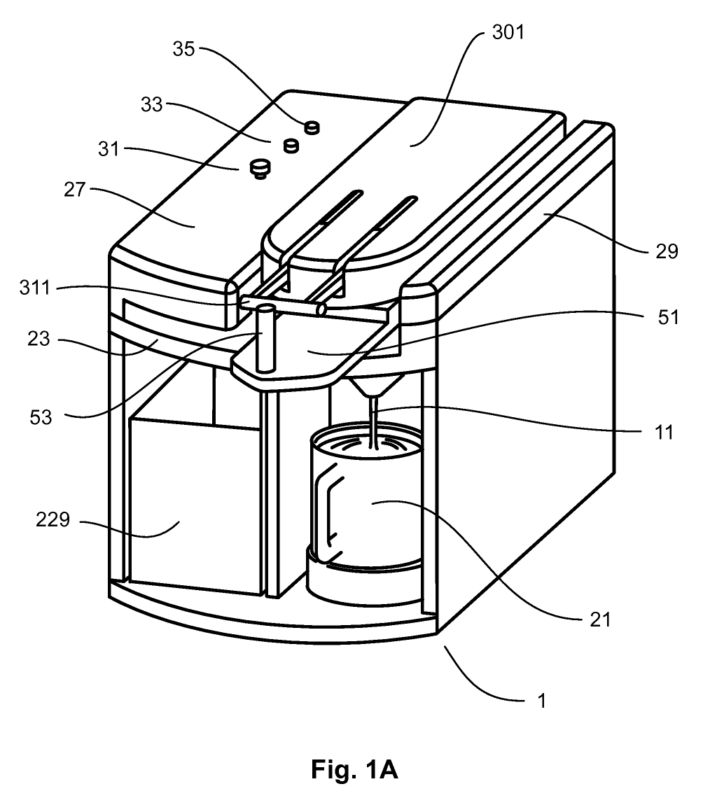

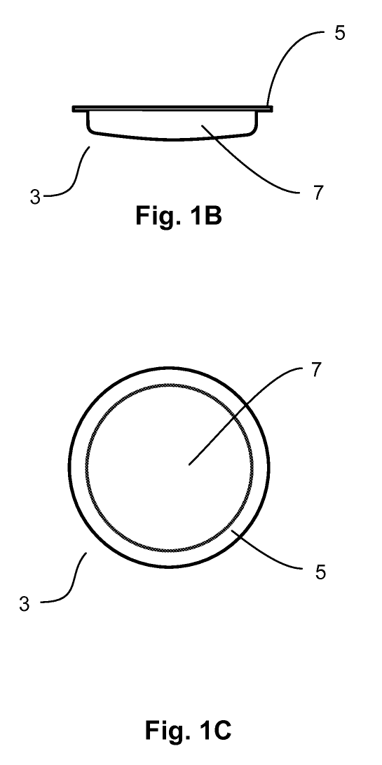

FIG. 1 shows a perspective view of the single cup beverage pod brewing invention 1. The invention 1 is shown dispensing brewed beverage 11 into a mug 21. The invention 1, as shown here, possesses a start switch 31, a first brew cycle indicator light 33 and a second brew cycle indicator light 35. The switch and light are shown in this embodiment as being secured to a left top cover 27. The invention also possesses a pivot arm 301 secured in part by a brew arm latch 311, the pivot arm sealing around a beverage pod held within a brew pod slider 51. Upon completion of the brewing cycle, the user may slide the slider 51 from a first brew position, to a second position where the brew pod is ejected into a trash bin 229.

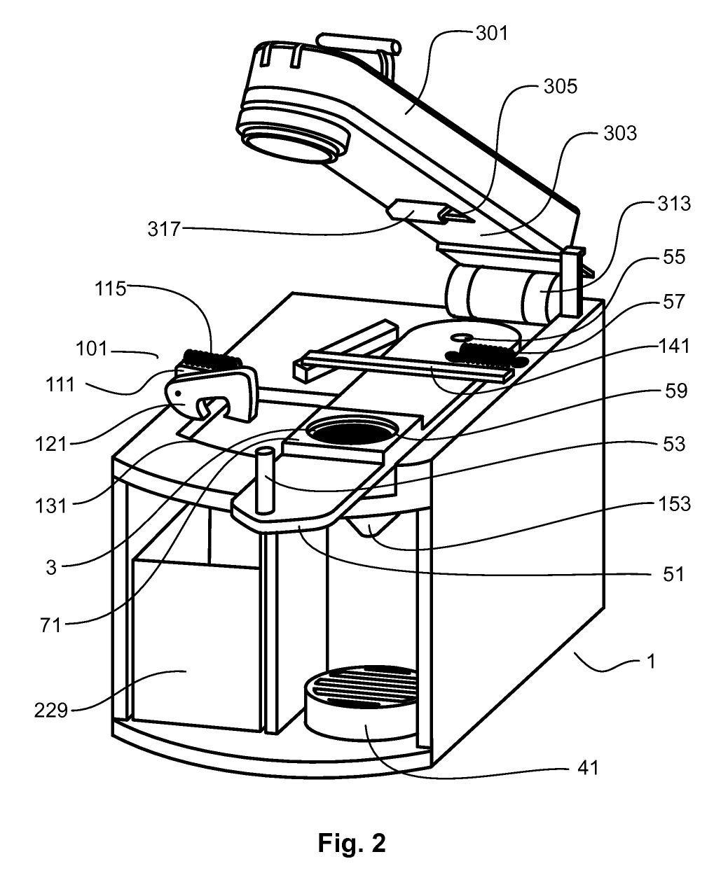

FIG. 2 shows a perspective view of the invention 1, with the left top cover 27 removed showing the ejection lever bracket 111, ejection spring 115, and ejection lever 121 of the pod ejection mechanism 101. The pivot arm 301 is shown pivoted about the pivot arm hinge 313 in an upward rotated position. The pivot arm bottom surface 303 possesses an aperture 305 through which a portion of the lock lever 317 extends. When the pivot arm 301 is in the closed or downward position, the lock lever 317 latches under the lock lever bar 141 holding the pivot arm 301 in the downward closed position. When the pivot arm 301 is in the upward or open position as shown, a user may press the slider handle 53 to the left, moving the slider 51 from a first position, shown, to a second position, the slider pivoting about a slider pivot 55. When the slider 301 is in the second position, the pod 3 is ejected from the pod alignment hole 59 through the pod ejection aperture 131 by the pod ejector assembly 101 into the trash bin 229. The pod alignment aperture 59 is positioned within a raised portion of the slider 51, referred to herein as the brew guide plate 71. The slider 51 is shown here to be biased to return to the first position by a slider spring 57. An overflow drip receptacle 41 is positioned below the brew funnel 153.

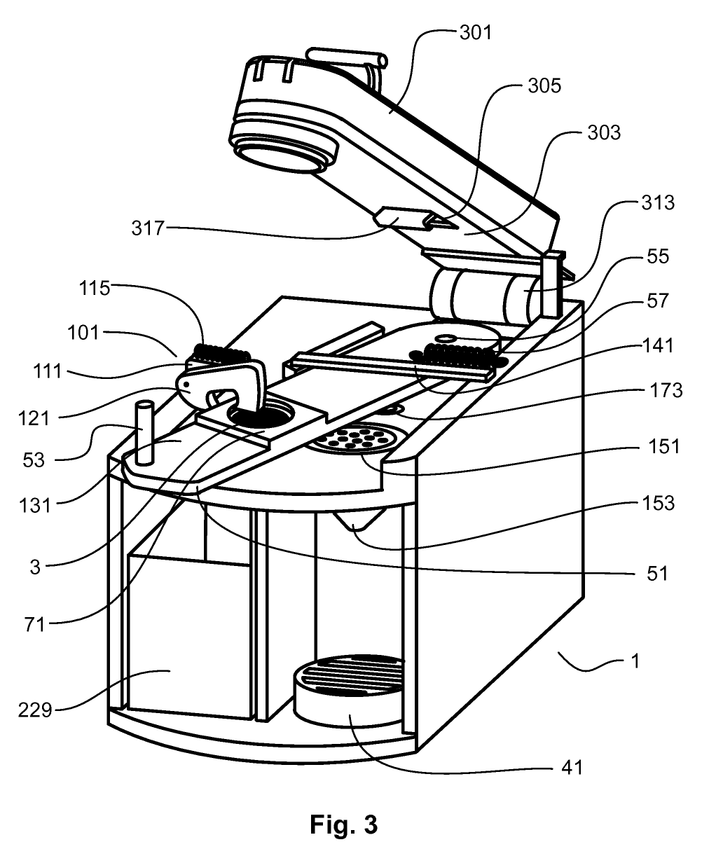

FIG. 3 shows the slider 51 in a transitory position between the first and second positions. In this transitory position, the ejection mechanism 101 engages the slider 51. Particularly, the ejection lever 121 engages the slider left surface 63. In the transitory position, the brew pod screen 151 can be viewed. The brew pod screen 151 supports the brew pod 3 when the beverage is being brewed, preventing the pod 3 and its contents from entering the brew funnel 153. A slider position roller 173 may be present and biased against the slider 51 to assist in maintaining the slider in a desired position.

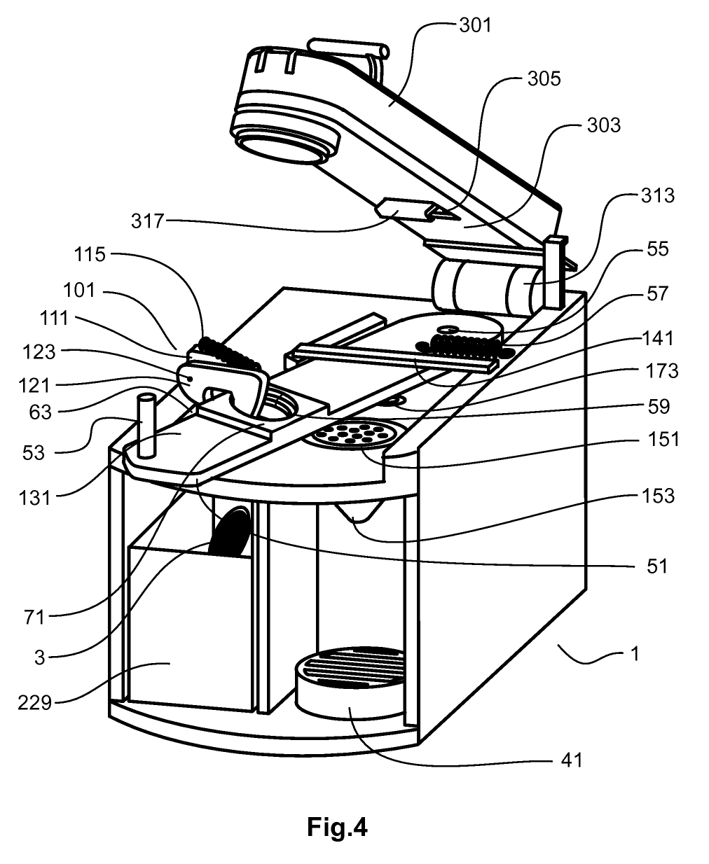

FIG. 4 shows the slider in the second position, pod ejection position. In this position, the pod 3, is urged through the pod alignment aperture 59 by the ejection mechanism 101. The slider left surface 63 presses against the ejection lever 121 slider contact arm 125 causing the ejection lever to rotate about a pivot 123. Contact of the slider 51 with the slider contact arm 125 of the ejection lever 121 forces the ejection lever pod contact arm 127 downwards urging the pod 3 through the pod alignment aperture 59 and pod ejection aperture 131 and into the trash receptacle 229. Contact of the ejection lever 121 against the outside wall 63 of the slider 51 prevents the ejection mechanism from pinching the pod 3 between the lever 121 and pod alignment aperture 59. The ejection lever pod contact arm 127 is biased to return to an upward position. In the current embodiment of the invention, the ejection lever pod contact arm 127 is biased by an ejection spring 115 under tension attached at the top of the ejection lever 121.

Trash bin 229 may be removed and emptied when desired. In the preferred embodiment, a reused pod packaging box may be used as the trash bin 229, reducing waste, while eliminating the need to rinse or clean a reused trash bin 229. The reused pod packaging box has the additional advantage of prominently displaying the pod manufacturer's trade name and trademarks.

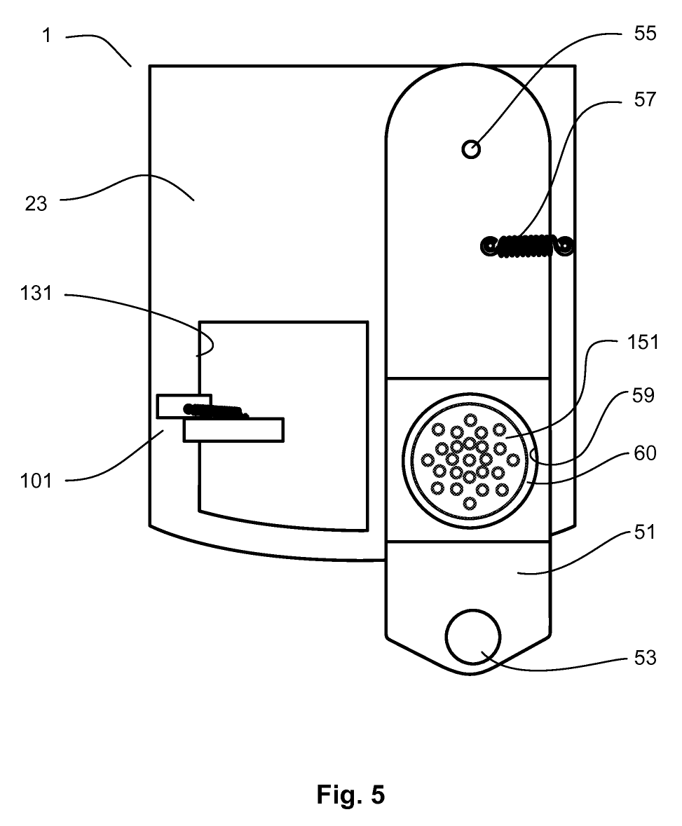

FIG. 5 shows an overhead view of the brewing device with the top covers 27, 29 removed. The slider 51 is shown in a first, ready-to-brew, position, with the pod alignment aperture 59 aligned with the brew pod screen 151. The pod alignment aperture 59 possesses a recessed pod flange support ledge 60. The Pod flange support 60 supports the underside of the pod flange 5 and also aids in centering the body 7 of the pod 3 within the pod alignment aperture 59. The current embodiment shows the slider biased to return to the first position by the slider spring 57. A handle 53 is positioned at the front end of the slide 51. To operate the slide 51, initiating the pod ejection procedure, a user moves grasps the handle 53 and moves the slider 51 to the left. The slider rotates about the slider pivot 55 until the pod alignment aperture 59 is positioned above the pod ejection aperture.

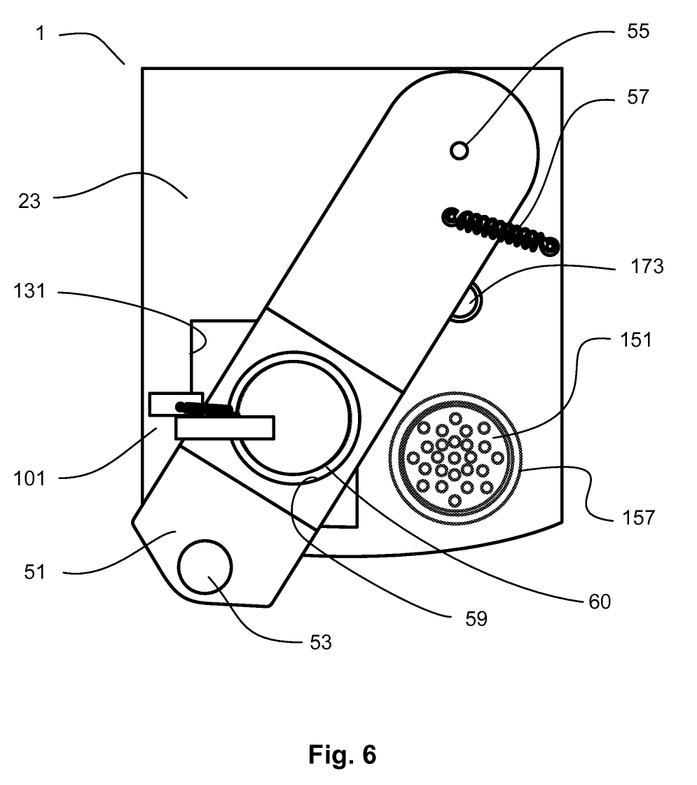

FIG. 6 shows an overhead view of the brewing device with the top covers 27, 29 removed. The slider 51 is shown in a second, ready-to-eject, position, with the pod alignment aperture 59 aligned with the pod ejection aperture 131. In this position, further movement of the slider handle 53 and slider 51 to the left results in contact of the slider left surface 63 against the ejection lever 121 slider contact arm 125 causing the ejection lever to rotate about a pivot 123. Contact of the slider 51 with the slider contact arm 125 of the ejection lever 121 forces the ejection lever pod contact arm 127 downwards urging the pod 3 through the pod alignment aperture 59 and pod ejection aperture 131. Movement of the slider 51 to the right allows the biased ejection lever 121 to return to a resting position. While the current embodiment shows the ejection lever 121 biased with a spring 115, it should be understood that the ejection lever may be biased by other methods, including weight or resilient materials. A brew screen gasket 155 positioned around the brew screen 151 seals the top wall 23 of the invention 1 and bottom surface of the slider 51.

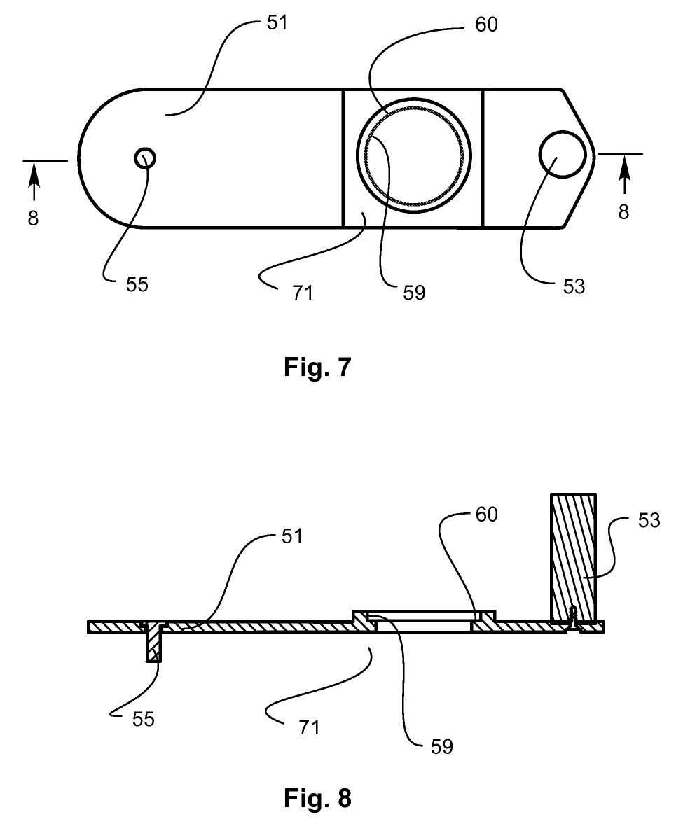

FIG. 7 shows a top view of the slider 51, showing the slider hinge 55, slider handle 53, pod alignment aperture 59 and the raised brew guide plate 71. The pod flange support 60 protrudes into the pod alignment aperture 59, providing a ledge upon which the pod flange 5 rests.

FIG. 8 is a cross section view through line 8-8 of FIG. 7. FIG. 8 shows the slider hinge 55, slider handle 53, pod alignment aperture 59 pod flange support 60 and the raised brew guide plate 71. While the current embodiment shows the brew guide plate 71 as a separate piece secured to the slider 51, the brew guide plate 71 may be a raised portion of an otherwise continuous slider 51, or may be omitted altogether.

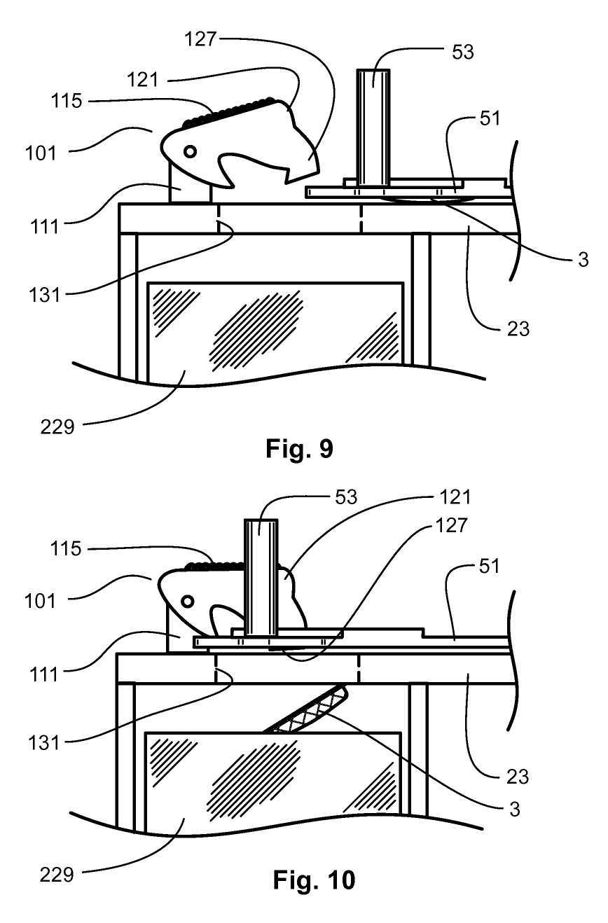

FIG. 9 is a rear view of the ejection mechanism 101 and invention 1 showing the ejection mechanism 101, slider 51, top wall 23 and trash bin 229. Here the ejection cam 121 is in an elevated and ready position. The user has begun to swing the slider 51 to the left. The ejection lever 121 pod contact arm 127 is sufficiently elevated to clear the top surface 73 of the brew guide plate 71.

FIG. 10 is a rear view of the ejection mechanism 101 and invention 1 showing the ejection mechanism 101, slider 51, top wall 23 and trash bin 229. The slider is in the second position just as the pod 3 is being ejected from the slider 51 by the ejection mechanism 101. Here the ejection cam 121 is in a downward position, the ejection lever slider contact arm 125 in contact with the outer edge of the slider 51 forcing the pod contact arm 127 downward. The pod flange 5 is forced through past the pod flange support 60, releasing the pod 3 from the slider and allowing it to drop into a trash receptacle 229 below.

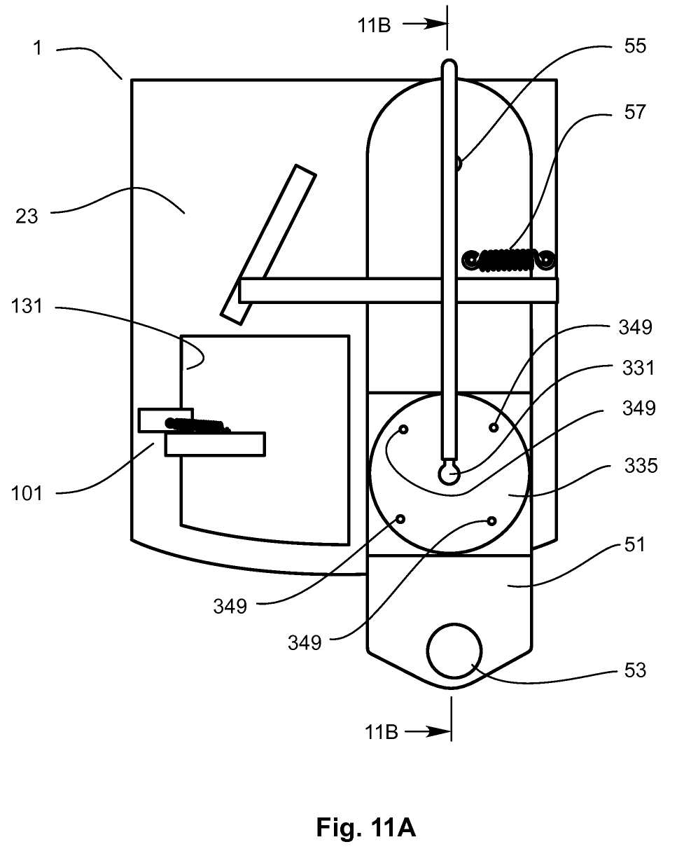

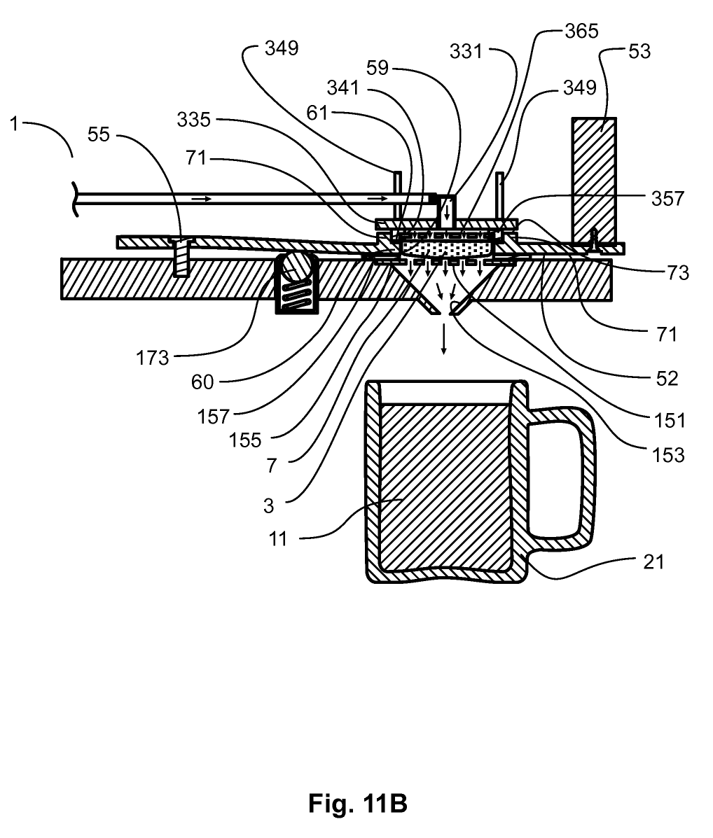

FIG. 11 is a sectional view of the slider and brew head taken on line 11-11 of FIG. 5. When the pivot arm 301 is in the down and locked position, the top surface 24 of the base plate 23 of the invention is urged toward the bottom surface 52 of the slider 51 sealing the two surfaces against the brew screen gasket 157 located therebetween. The portion above the slider 51 is sealed by the brew head gasket 357 located between the brew base plate 335 and slider 51. In the current embodiment, the brew head gasket 357 pinches the pod flange 5 between the gasket 357 and the top surface 61 of the pod flange support 60. This forces the water exiting the spray head 365 to travel through the pod body 7 and prevents water from bypassing the pod 3 by traveling around the pod flange 5. While the sealing of the brew head gasket 357 against the pod flange 5 and base plate 335 may be sufficient to prevent egress of water above the slider 51 under certain pressures, high pressure leaks may be prevented by the radial bulging of the brew head gasket 357. In the current embodiment, the resilient brew head gasket 357 seals the brew base plate 335 against the slider 51, while the resilient radial bulging against the spray head 365 and surface of the pod alignment aperture 59 provide additional assurances against water egress.

In operation, after the pivot arm 301 is in a down and locked position, hot water is pumped in through the water inlet fitting 339 and through the spray head 365. The water then is forced through the body 7 of the pod 3 which contains the ground or otherwise prepared beverage media. The pod 3 is supported by the pod screen 151 The brewed beverage 11 exits the pod 3 entering the brew funnel 153 where the brewed beverage 11 then flows into the user's cup 21.

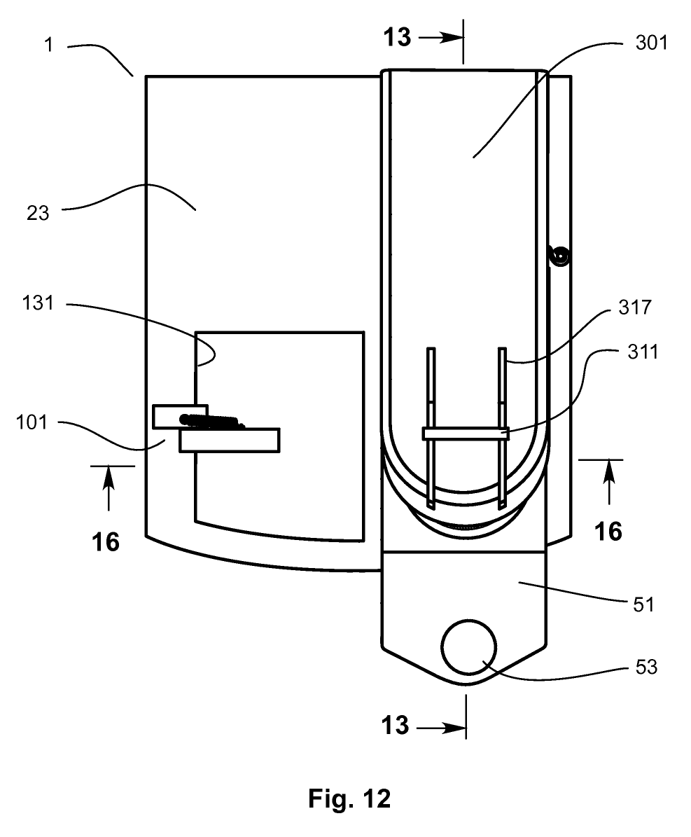

FIG. 12 is a top view of the invention 1 showing the brew arm 311 and pivot arm 301 in an open and unlocked position.

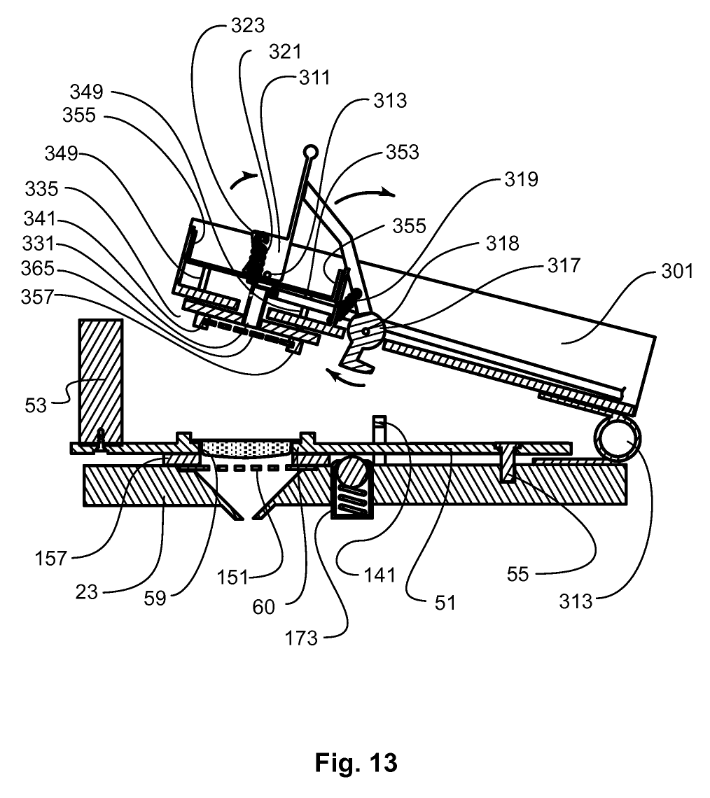

FIG. 13 is a cross section of the pivot arm 301 and top wall 23 of the invention taken alone line 13-13 of FIG. 12. Here the brew arm 311 and pivot arm 301 are in their open and unlocked positions. The brew arm 311 pivots about brew arm pivot pin 315 and urges the lock lever 317 into a release position, releasing the lock lever bar 141. The lock lever 317 is otherwise biased into a closed and lock position retaining the lock lever 317 and pivot arm 301 down. In the current embodiment, the lock lever 317 is pivotally attached to the pivot arm 301 by a lock lever pin 318 is biased to a locking position by a tension spring 319. While in the open and unlocked position, the brew base plate 335 is raised toward the pivot arm 301 by tension spring 321 allowing the slider 51 to slide from a first position for brewing to a second position for pod ejection. The brew base plate 335 is attached to the brew arm slide plate 353 by a plurality of guide pins 349. Tension spring 321 on one end is attached to the brew arm slide plate 353 and on the other end to the brew arm 311 by spring pin 323. In the current embodiment, slide plate guides 355 prevent unwanted rotation or horizontal translation of the brew arm slide plate 353. The pivot arm 301 rotates about the brew arm hinge 313 allowing the user to insert a fresh pod 3 into the pod alignment aperture 59.

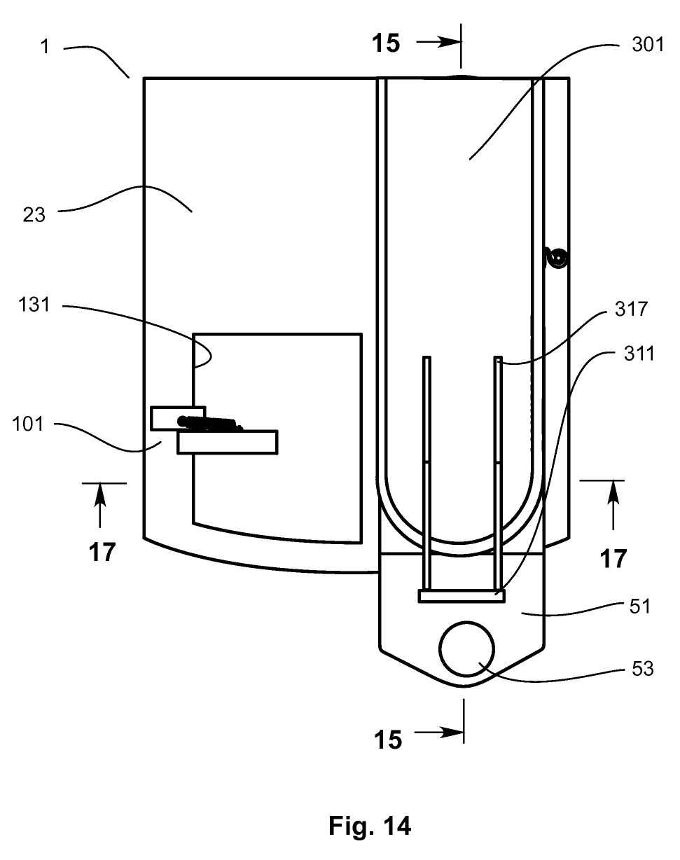

FIG. 14 is a top view of the invention 1 showing the brew arm 311 and pivot arm 301 in a closed and locked position over the slider 51.

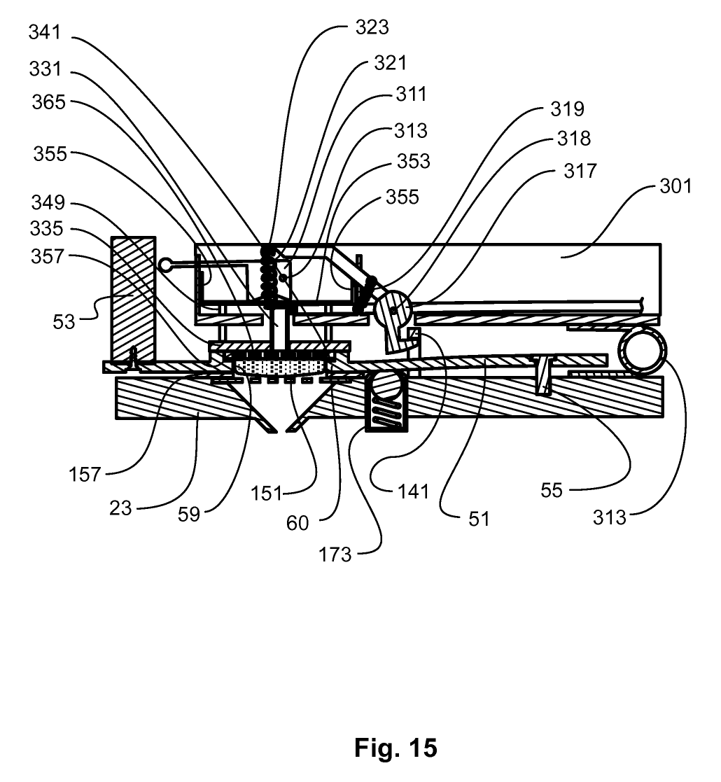

FIG. 15 is a cross section of the pivot arm 301 and top wall 23 of the invention taken alone line 15-15 of FIG. 14. Here the brew arm 311 and pivot arm 301 are in closed and locked positions. The pivot arm is held in a closed position by the lock lever 317 which is pivotally retained to the brew arm 311 by a pin 318 and hooked onto the lock lever bar 141. The brew arm 311 is pinned to the pivot arm 301 by the brew arm pin 313 and possesses a cam profile allowing it to urge the brew base plate downward and compress the brew head gasket 357 against the pod flange 5, pod flange support 60 and compressing the screen gasket 157 against the top wall 23 of the invention 1. The brew arm 313 cam profile locks the brew arm in this closed position until urged by the user into an upward, unlocked position. The lock lever 317 is biased to remain in a closed and lock position retaining the lock lever 317 and pivot arm 301 down. In the current embodiment, the lock lever 317 is pivotally attached to the pivot arm 301 by a lock lever pin 318 is biased to a locking position by a tension spring 319. While in the closed and locked position, the brew chamber 371, now a quasi-sealed pressure vessel with a single outlet, directs the pressure of the hot water pumped from the water inlet fitting 331 down through the spray head 365 though the pod body 7 past the pod screen 151 into the brew funnel 153 and into the beverage receptacle 21. The current embodiment possesses a slider position roller 173 which aids in maintaining the slider 51 position.

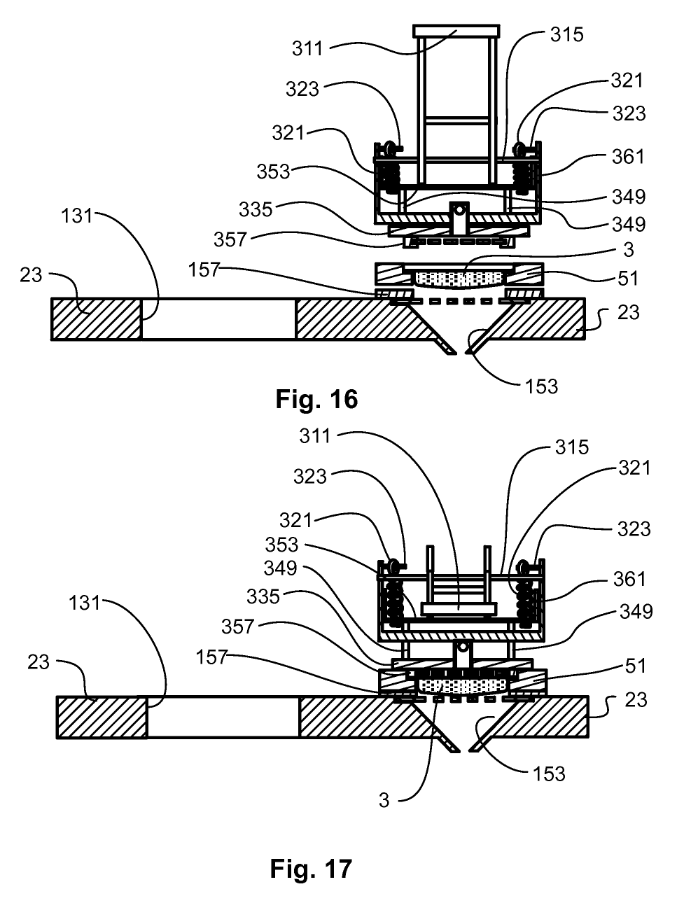

FIG. 16 is a cross section of the pivot arm 301 and top wall 23 of the invention showing the pivot arm 301 and brew arm 311 in an open unlocked position taken on line 16-16 of FIG. 12. In this position the slider 51 is able to be urged left to right when the user presses the handle 53 in the desired direction. The drawing shows the current embodiment having a clearance gap in the open unlocked position between the brew head gasket 357 and slider 51 and a clearance gap between the slider 51 and the screen gasket 157.

FIG. 17 is a cross section of the pivot arm 301 and top wall 23 of the invention showing the pivot arm 301 and brew arm 311 in a closed locked position taken on line 17-17 of FIG. 14. In this position have pressed the brew base plate 335 and brew head gasket against the pod 3 flange 5 and pod flange support 60. The slider 51, in turn is urged against the screen gasket 157 and top wall 23 of the invention, creating a quasi sealed brew chamber where water enters through the spray head 365 and permeates through the beverage pot 3 body 7 under pressure, finally exiting through the brew funnel 153 and into the user's cup 21.

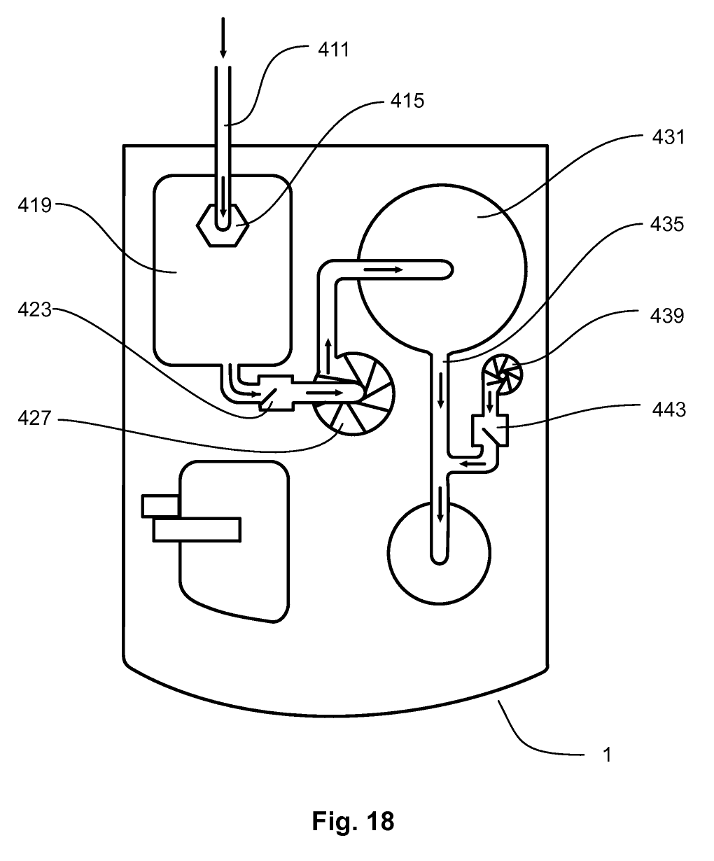

FIG. 18 is a schematic of the invention 1 showing the current embodiment's pressure and heating system. Fresh water enters through tube 411 through a valve 415 into a reservoir tank 419. Valve 415, such as a float valve, ensures a proper level of water is maintained in tank 419, the water ready to be pumped through the machine. A water pump 427 pumps the water through a check valve 423 and into a heating tank 431. The cooler water displaces already heated water forcing the hot water out through the pivot arm tube 435 and into the brew chamber. Once a predetermined amount of heated water has been ejected through the brew chamber, the water pump 427 stops and an air pump 439 pumps air through an air check valve 443 and into the brew chamber, removing excess water from the brew chamber and brew pod 3. The system may be controlled electronically or mechanically as known in the art.

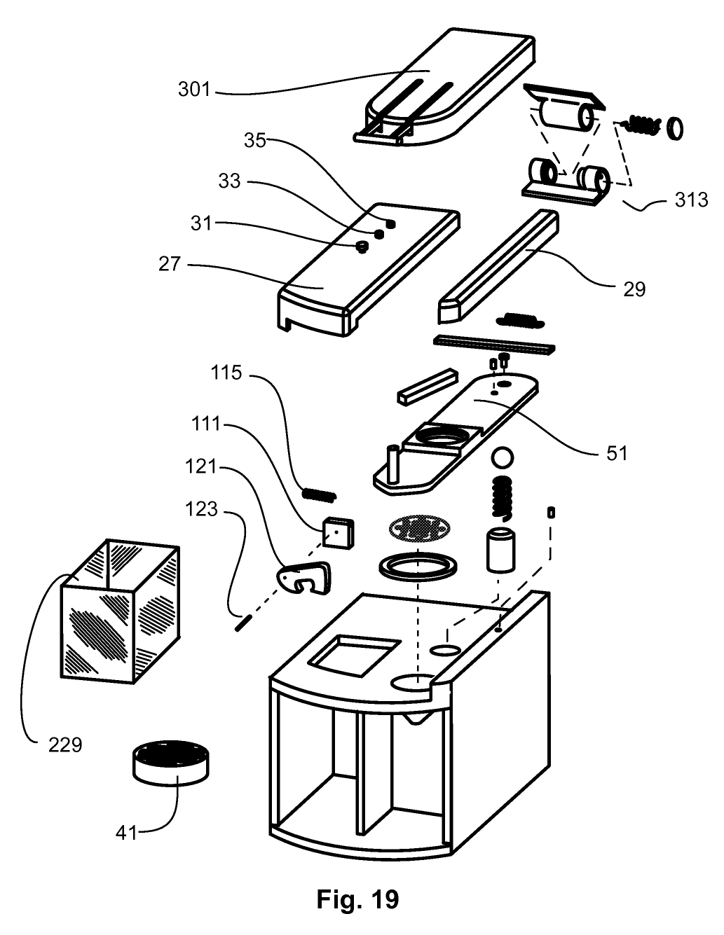

FIG. 19 is an exploded perspective view of the invention 1 showing the major assemblies. Shown here are the pivot arm 301, spring biased pivot arm hinge assembly 313, left top cover 27, right top cover 29, slider 51, ejection lever 121, ejection spring 115, ejection lever bracket 111, and ejection pivot pin 123.

What is claimed is:

1. A beverage brewing apparatus for brewing using a filter pod having a top, a bottom, and an outer circumferential flange, said apparatus comprising:
a brew chamber having an upper portion and a lower portion;
said brew chamber lower portion positioned below said brew chamber upper portion, said brew chamber lower portion having at least one aperture;
a sliding pod carrier having a top, a bottom, an outer wall, and a pod alignment aperture, said pod alignment aperture passing from said top to said bottom, said sliding pod carrier having a first carrier position and a second carrier position;
an ejection lever having a first lever position and a second lever position, said ejection lever biased to said first lever position;
an ejected pod receptacle;
whereas when said sliding pod carrier is moved by a user to said second carrier position, said sliding pod carrier's said outer wall urges said ejection lever from said first lever position to said second position wherein said ejection lever presses upon said top of said pod, dislodging said pod from said carrier.

2. The apparatus of claim 1 wherein said circumferential flange of said pod is pinched between a gasket attached to the bottom of said upper brew chamber and said sliding pod carrier.

3. The apparatus of claim 2 wherein said gasket possesses a retaining groove, said retaining groove retaining a spray head.
